(19) United States
(12) Patent Application Publication
(10) Pub. No.: US 2022/0162463 A1
(43) Pub. Date: May 26, 2022

(54) ERASABLE AQUEOUS INK

(71) Applicant: Société BIC, Clichy (FR)

(72) Inventors: Alexander BOURQUE, Clichy (FR); Aurore SAUVAGE, Clichy (FR)

(21) Appl. No.: 17/602,509

(22) PCT Filed: Apr. 6, 2020
(86) PCT No.: PCT/EP2020/059751

§ 371 Date: Oct. 8, 2021

(30) Foreign Application Priority Data
Apr. 9, 2019 (EP) 19305459.0

(51) Int. Cl. C09D 11/17; C09D 11/18

(52) U.S. Cl. CPC C09D 11/17; B43K 7/00; C09D 11/18

(57) ABSTRACT

An erasable aqueous non-thermochromic writing ink having core-shell dye microparticles, wherein the core of the core-shell dye microparticles has an organic solvent immiscible with water and at least one dye soluble in the organic solvent and the shell includes a resin component.

There is also a writing instrument containing the ink, a process of preparation of the ink and the use of the core-shell dye microparticles as the only coloring agent in the ink.

### CROSS REFERENCE TO RELATED APPLICATIONS

This application is a National Stage Application of PCT Application No. PCT/EP2020/059751, filed on Apr. 6, 2020, now published as WO2020207966, which claims priority from EP19305459.0, filed on Apr. 9, 2019, the entire contents of both of which are incorporated herein by reference.

### Field of the Disclosure

The present disclosure concerns erasable aqueous non-thermochromic writing ink. This type of inks can be erased by an eraser after writing, in particular by a rubber eraser. Thermochromic inks are erasable by the use of the heat generated by the friction of the eraser. However, the erasure is reversible with low temperature and therefore the erased draw lines can be regenerated unwantedly. Moreover their use is not possible in countries where the temperature is often high or often very low because color and erasability depends on temperature. Furthermore the colors obtained by the use of these inks are not very vivid and are not resistant to UV-light because of the use of leuco-dyes.

### Description of the Related Art

Inks erasable by peeling (such as by a rubber eraser) are known in the art such as in U.S. Pat. No. 5,661,197. However, the dyes used in the polymer-encapsulated colorant disclosed in this document have to be soluble in the monomer intended for its encapsulation. Moreover the monomer has to be insoluble in water in order to perform emulsion polymerization. Furthermore the polymer-encapsulated colorant particles have a very low diameter (between 25 to 1000 nm) and therefore will penetrate deep into the paper fibers and be difficult to erase by mechanical action such as peeling.

Therefore there is a need to find new erasable non-thermochromic inks having a good erasability by mechanical action, avoiding an unwanted color return or an unwanted colorloss due to a change in temperature, having high color intensity and multiple choices of colors.

### SUMMARY OF THE DISCLOSURE

The inventors have surprisingly found that the use of core-shell dye microparticles, in which the core comprises an organic solvent immiscible with water and at least one dye soluble in the organic solvent and the shell includes a resin component, can resolve the above-mentioned problem and have all the desired above-mentioned advantages. They are also resistant to UV light in order to avoid discoloration under the sun over time.

Furthermore, the erasable aqueous non-thermochromic writing ink composition of disclosure enables obtaining vivid colors of written marks once applied on porous substrates.

An additional advantage of the disclosure is to enable to include in the ink composition solid particles, such as core-shell dye microparticles, in particular above a specific size, without clogging the pen point.

The present disclosure therefore concerns an erasable aqueous non-thermochromic writing ink comprising core-shell dye microparticles, wherein the core of the core-shell dye microparticles comprises an organic solvent immiscible with water and at least one dye soluble in the organic solvent and the shell includes a resin component.

In the sense of the present inven, the expression “comprising a” should be understood as being synonymous with “comprising at least one”.

In the sense of the present disclosure, the expressions “between . . . and . . . ” or “ranging from . . . to . . . ” should be understood as including the values of the limits.

The ink according to the present disclosure is a non-thermochromic ink. For the purposes of the present disclosure, the term “non-thermochromic ink” is intended to mean any ink which will not be erased or will not change its color due to a change in temperature such as an increase or a decrease.

### DETAILED DESCRIPTION OF THE DISCLOSURE

The ink according to the present disclosure is erasable, more specifically by peeling (such as by mechanical friction), in particular by the use of an eraser such as a rubber, more specifically a rubber which is made of a blend of ethylene-propylene-diene monomer rubber and polypropylene.

For the purposes of the present disclosure, the term “erasable ink” is intended to mean any ink which can be erased after writing. The written mark obtained, in particular on cellulosic fiber paper such as paper (printer paper for example) and cardboard paper, by this ink can therefore be erased just after writing such as less than 5 second after writing, and also even a few days after writing.

The ink according to the present disclosure is more specifically irreversibly erased. It is therefore an irreversible erasable ink.

The ink according to the present disclosure is a writing ink. For the purposes of the present disclosure, the term “writing ink” is intended to mean any ink which is intended to be used in a writing instrument, in particular in a pen such as a ball-pen. A writing ink should not be confused with a printing ink which is used in printing machines and which does not have the same technical constraints and thus the same specifications. Indeed, a writing ink must not contain solid particles of which the size is greater than the channels of the writing instrument, in order to avoid blocking them, which would inevitably lead to writing being irreversibly stopped. It must also dry sufficiently rapidly to avoid smudging the writing medium. It must also avoid the problems of migration (bleeding) over time. Thus, the ink according to the present disclosure will be suitable for the writing instrument for which it is intended, in particular for a pen such as a ball-pen.

More specifically, the erasable aqueous non-thermochromic writing ink composition of disclosure enables obtaining vivid colors of written marks once applied on porous substrates (also named porous surfaces). For the purposes of the present disclosure, the term “porous substrate” is intended to mean substrate that contains pores. The porous substrates have empty spaces or pores that allow external matter, like ink, to penetrate into the substrate.

Specifically, the ink composition according to the disclosure comprises solid particles, such as core-shell dye microparticles, in particular above a specific size, without clogging the pen point. More specifically, the adherence of the composition according to the disclosure is sufficient to avoid having it being removed inadvertently from the surface on which it had been applied, but allows removing it efficiently when specifically rubbed, in particular with an eraser or friction body, in particular from porous substrate.

Moreover, the ink composition according to the disclosure shows good stability, in particular with regards to the dispersion of the microparticles; more specifically no sedimentation phenomenon is to be observed.

The ink according to the present disclosure contains core-shell dye microparticles. For the purposes of the present disclosure, the term “core-shell dye microparticles” are microscale particles whose core and shell are different in composition and the core contains a dye. Therefore these particles have the function of a coloring agent in the ink according to the present disclosure. More specifically these particles have the color of the dyes contained therein.

More specifically the core-shell dye microparticles of the ink according to the present disclosure have a mean diameter in intensity D50 measured by dynamic light scattering such as Malvern Mastersizer 3000E in the range 4-20 μm, more specifically in the range 4-15 μm, still more specifically in the range 4-12 μm, still more specifically in the range 4-8 μm.

Indeed if the mean diameter D50 is lower than 4 μm, there is a high probability that the microparticles will penetrate deep into the paper fibers and will be difficult to erase.

Moreover if the mean diameter D50 is higher than 20 μm, there is a high probability that there will be a clogging of the point of the ballpoint pen and this ink will not be usable with such a writing instrument.

The core-shell dye microparticles can have different forms, but more specifically they are spherical and therefore the microparticles are microspheres, even more specifically the microparticles are microcapsules.

In an advantageous manner, the amount of the core-shell dye microparticles in the ink according to the present disclosure is within the range 5-40 weight %, more specifically 10-35 weight %, even more specifically 15-30 weight % based on the total weight of the ink.

Ink compositions of the present disclosure enable surprisingly to obtain core-shell microcapsules of a diameter mean diameter in intensity D50 above a specific size, sufficient to prevent those from penetrating into the spaces or pores of the porous substrate (such as paper) and at the same time, without clogging the pen point.

Without wishing to be bound to a theory, the core-shell microcapsules present in the ink composition of the present disclosure are believed to be supple enough to avoid these from clogging the pen point, on contrary to harder particles.

The core of the microparticles comprises an organic solvent immiscible with water and at least one dye soluble in the organic solvent, and more specifically insoluble in water. For the purposes of the present disclosure, the term “an organic solvent immiscible with water” is intended to mean any organic solvent having a solubility in water lower than 30 g/L. The organic solvent of the microparticle's core is therefore immiscible with water and more specifically selected in the group consisting of petroleum solvents such as paraffinic alkanes, esters such as isopropyl myristate and octyl acetate, ethers such as dibutyl ether, aryl ethers and arylalkyl ethers, glycol ethers such as 2-phenoxyethanol, fatty alcohols such as 1-octadecanol, amines, terpenes, naphthenic solvent such as alkylated naphthalene, halogenated solvents such as trichloromethane, chlorinated diphenyl, chlorinated paraffin and monochlorobenzene, ketones such as heptadecan-9-one, cottonseed oil, groundnut oil, silicone oil, tricresyl phosphate, partially hydrogenated terphenyls, alkylated diphenyls and mixture thereof, even more specifically it is selected in the group consisting of petroleum solvents such as paraffinic alkanes, esters such as isopropyl myristate and octyl acetate, ethers such as dibutyl ether, glycol ethers such as 2-phenoxyethanol, fatty alcohols such as 1-octadecanol, amines, terpenes, naphthenic solvent, halogenated solvents such as trichloromethane, chlorinated diphenyl, chlorinated paraffin and monochlorobenzene, ketones such as heptadecan-9-one and mixture thereof, still more specifically it is selected in the group consisting of isopropyl myristate, heptadecan-9-one, 1-octadecanol and mixture thereof, in particular it is 1-octadecanol.

More specifically the organic solvent content of the microparticle's core is in the range 75-98 weight % based on the total weight of the microparticle's core, even more specifically in the range 80-95 weight % based on the total weight of the microparticle's core, still more specifically in the range 85-90 weight % based on the total weight of the microparticle's core.

The microparticle's core also contains at least one dye, in particular a mixture of dyes, which is soluble in the organic solvent. More specifically the dye is insoluble in water. The dye can be selected for example in the group consisting for Sudan Red 380, Sudan blue 670, Baso Red 546, Baso Blue 688, Sudan yellow 150, Baso Blue 645, Flexo Yellow 110, Flexo Blue 630, Oil Red 235, Morfast Yellow 101, Nitro Fast Yellow B, Macrolex Yellow 6 G, Solvent Yellow 14, 16 and 21, Solvent Orange 45, 62, Solvent Red 1, 7, 8, 49, 119, and 125, Solvent Blue 5, 14, 25, 36 and 51 and Solvent Black 5 and 34 and mixtures thereof. The dye can belong to the solvent dye class such as : triphenylmethane compounds such as 3,3-bis-(p-dimethylaminophenyl)-6-dimethylaminophtalide («crystal violet lactone») and 3,3-bis-(p(dimethyl-amino-phenyl)-phtalide («malachite green lactone»), diphenylmethane compounds such as 4,4-bis-dimethylaminobenzhydryl benzyl ether, N-2,4,5-trichlorophenylleucauramine N-halogenophenylleucauramine, N-β-naphthylleucauramine, N-2,4-dichlorophenylleucauramine, xanthene compounds such as rhodamine-β-anilinolactam, rhodamine-β-(p-nitroaniline)-lactam, rhodamine-β-(p-chloroaniline)-lactam, 7-dimethyl-amine-2-methoxy-fluoran, 7-diethylamine-3-methoxyfluoran, 7-diethylamine-3-methylfluoran, 7-diethylamine-3-chlorofluoran, 7-diethylamine-3-chloro-2-methylfluoran, 7-diethylamine-2,4-dimethylfluoran, 7-diethylamine-2,3-dimethylfluoran, 7-diethylamine-(3-acetyl-methylamine)-fluoran, 7-diethyl-amine-3-methylfluoran, 3,7-diethyl-aminefluoran, 7-diethylamino-3-(diebnzylamine)-fluoran, 7-diethylamine-3-(methylbenzylamine)-fluorane), 7-diethylamine-3-(dichlorethylamine)-fluoran, 7-diethylamine-3-(diethylamine)-fluoran, thiazine compounds such as N-benzoylleucomethylene blue, o-chlorobenzoylleucomethylene blue and p-nitrobenzoylleucomethylene blue, and spiropyran compounds such as 3-methyl-2-2′-spiro-bis-(benzo(f)-chromene). It can be any mixtures of these dyes.

More specifically , the dye content of the microparticle's core is in the range 2-25 weight % based on the total weight of the microparticle's core, even more specifically in the range 5-20 weight % based on the total weight of the microparticle's core, still more specifically in the range 10-15 weight % based on the total weight of the microparticle's core.

The microparticle's core can contain other components well known by the one skilled in the art such as antioxidants, anti-UV agents, pH-adjustors and mixtures thereof. More specifically it does not contain any other components and consists of the organic solvent and at least one dye. Still more specifically it is the at least one dye (in particular the mixture of dyes) contained in the core of the microparticle which will give the color to the microparticle.

The shell of the microparticle includes a resin component which is more specifically insoluble in water. Even more specifically the precursor of the resin component (used during the process of preparation of the core-shell microparticle) is soluble in water.

The resin component can be selected in the group consisting of polymer of urethane resin, melamine resin, urea resin, benzoguanamine resin, phenol resin, epoxy resin, natural polymers such as sodium alginate, gelatin cellulosic polymer such as ethylcellulose, hydroxypropylcellulose and mixture thereof, more specifically it is a melamine resin.

The shell can contain other components well known by the one skilled in the art such as a surfactant. More specifically it does not contain any coloring agent such as a dye or a pigment. Even more specifically the shell consists in the resin component only and therefore does not contain any other component. Still more specifically, the resin component is not a colored resin component and the shell can be colorless or even transparent.

The aqueous erasable ink according to the present disclosure contains water as the solvent. More specifically the amount of water in the ink according to the present disclosure is comprised between 20-80 weight %, more specifically 30-70 weight % based on the total weight of the ink.

More specifically, the ink comprises a rheology modifying agent, in particular capable of generating a gelling effect, even more specifically selected in the group consisting of synthetic polymers (for example polyacrylic acids, polyvinyl alcohol, polyethylene oxide, polyvinylpyrrolidone, polyvinyl methyl ether, polyacrylamide and mixture thereof), cellulosic derivatives (such as cellulose nanofibers, hydroxyethyl cellulose, carboxymethylcellulose and mixture thereof), polysaccharides (such as xanthan gum, gum arabic, carrageenan (in particular kappa and/or iota carrageenan, more specifically iota carrageenan), guar gum, casein, gelatin, alginic acid and salts thereof (in particular sodium alginate), tragacanth gum, locust beam gum and mixture thereof), still more specifically selected in the group consisting of xanthan gum, gum arabic, carrageenan, cellulose nanofibers, polyvinylpyrrolidone, cellulosic derivatives such as hydroxyethylcellulose, carboxymethylcellulose, and mixture thereof, in particular selected in the group consisting of xanthan gum, polyvinylpyrrolidone and mixture thereof, more particularly it is xanthan gum.

More specifically the amount of the rheology modifying agent in the ink according to the present disclosure is comprised between 0.05-5 weight %, more specifically 0.1-3 weight %, even more specifically 0.2-2.5 weight %, based on the total weight of the ink.

The erasable aqueous non-thermochromic writing ink according to the present disclosure can contain other additives known by the one skilled in the art to be usable in aqueous inks, more specifically selected in the group comprising water miscible solvents, anti-microbial agents, corrosion inhibitor agents, anti-foam agents, pH regulator agents, lubricants, coalescing agents, crosslinking agents, wetting agents, humectants, antioxidants, UV stabilizers, film-forming agents, dispersing agents, fungicides and mixture thereof.

More specifically the additive content of the ink according to the present disclosure is within the range 10-35 weight %, even more specifically 15-30 weight %, based on the total weight of the ink according to the present disclosure.

The ink according to the present disclosure can therefore more specifically contain at least a water miscible solvent such as polar solvents. More specifically the water miscible solvent can be selected in the group consisting of:

glycol such as ethylene glycol, diethylene glycol, triethylene glycol, polyethylene glycol, propylene glycol,

glycol ethers such as ethylene glycol monomethyl ether, ethylene glycol monoethyl ether, diethylene glycol monomethyl ether, diethylene glycol monoethyl ether, diethylene glycol monobutyl ether, dipropylene glycol monomethyl ether, dipropylene glycol monobutyl ether, dipropylene glycol monopropyl ether, tripropylene glycol monomethyl ether, and mixture thereof,

alcohols such as linear or branched alcohol in C₁-C₆ for example isopropanol, butanol, isobutanol, pentanol, benzyl alcohol, glycerin, diglycerin, polyglycerin and mixture thereof,

carbonate esters such as propylene carbonate, ethylene carbonate and mixture thereof,

lactame such as 2-pyrrolidone, N-methyl 2-pyrrolidone and mixture thereof,

ketones such as methylisobutylketone (MIBK), acetone, cyclohexanone and mixture thereof,

and mixtures thereof.

In an advantageous embodiment, the water miscible solvent is selected in the group consisting of glycol ethers, and even more specifically selected in the group consisting of glycerin, triethylene glycol, polyethylene glycol, 2-pyrrolidone, and mixture thereof, still more specifically it is glycerin.

More specifically, the water miscible solvent is present in the aqueous ink according to the present disclosure in an amount ranging from 5 to 50 weight %, even more specifically from 10 to 40 weight %, and even more specifically from 15 to 35 weight %, relative to the total weight of the aqueous ink.

The aqueous ink according to the present disclosure can contain an antimicrobial agent such as benzoic acid, sorbic acid, carbonic acid, zinc pyrrithione, sodium pyrrithione, sorbate, 2-bromo-2-nitropropane-1,3 diol (Bronopol® from Boots Company), isothiazolinones (ACTICIDE® from Thor), more specifically selected in the group consisting of 1,2-benzisothiazolin-3-one, 2-methyl-4-isothiazolin-3-one, and mixture thereof.

More specifically, the antimicrobial agent is present in the aqueous ink according to the disclosure in an amount ranging from 0.01 to 1 weight %, even more specifically ranging from 0.05 to 0.5 weight %, relative to the total weight of the aqueous ink.

The aqueous ink according to the present disclosure may comprise a corrosion inhibitor, more specifically selected in the group consisting of dicyclohexylammonium nitrile, diisopropylammonium nitrile, saponins, tolytriazole, benzotriazole, and mixture thereof, even more specifically selected in the group consisting of tolytriazole, benzotriazole, and mixture thereof.

More specifically, the corrosion inhibitor is present in the aqueous ink of the disclosure in an amount ranging from 0.01 to 1 weight %, even more specifically ranging from 0.05 to 0.5 weight %, relative to the total weight of the aqueous ink.

The aqueous ink according to the present disclosure may comprise an antifoam agent, more specifically a polysiloxane-based antifoam agent, and even more specifically an aqueous emulsion of modified polysiloxane (such as MOUSSEX® from Synthron, TEGO® Foamex from Evonik).

More specifically, the antifoam agent is present in the aqueous ink according to the present disclosure in an amount ranging from 0.01 to 1.5 weight %, even more specifically from 0.10 to 1 weight %, relative to the total weight of the aqueous ink.

The aqueous ink according to the present disclosure may comprise a film-forming agent which allows the fixation of the microparticles on the paper and avoids therefore the erasure of the ink by simply brushing it with the fingers or another sheet of paper while being erasable by a conventional eraser, such as a rubber eraser. It can be selected in the group consisting of polyvinylpyrrolidone, polyvinyl alcohol, an acrylic polymer, latex such as diene rubber such as a styrene-butadiene rubber, an acrylonitrile-butadiene rubber, a cis-1,4-polyisoprene rubber, and mixture thereof. More specifically, the film-forming agent is present in the aqueous ink according to the present disclosure in an amount ranging from 0.5 to 10 weight %, even more specifically from 1 to 7 weight %, relative to the total weight of the aqueous ink.

The aqueous ink according to the present disclosure may comprise a dispersing agent which is used for the stabilization of the microparticles in the ink in order to avoid the sedimentation, aggregation and maturation of the microparticles, such as fatty alcohols salts, fatty amines salts, polyurethanes, polyethers, polyacrylic salts, polyols.

More specifically, the dispersing agent is present in the aqueous ink according to the present disclosure in an amount ranging from 0.05 to 5 weight %, even more specifically from 0.1 to 3 weight %, relative to the total weight of the aqueous ink.

The aqueous ink according to the present disclosure may comprise other additives such as pH regulator agents, lubricants, coalescing agents, crosslinking agents, wetting agents, humectants, antioxidants, UV stabilizers, fungicides and mixture thereof. More specifically the other additive content of the ink according to the present disclosure is within the range 0.5-20 weight %, even more specifically 1-15 weight %, based on the total weight of the ink according to the present disclosure.

The lubricants can be fatty acids, such as oleic acid and its derivatives, polyether modified silicone oils, thiophosphite triesters, phosphate derivatives such as phosphoric ester, phosphate monoester of polyoxyethylene alkyl ether or polyoxyethylene aryl ether, phosphate diester of polyoxyethylene alkyl ether.

The pH controlling agent can be ammonia, urea, monoethanolamine, diethanolamine, triethanolamine, alkali metal salts of phosphoric acid such as tripolyphosphate, sodium carbonate and hydroxides of alkali metals such as sodium hydroxide.

More specifically the ink according to the present disclosure does not contain any other coloring agent than the core-shell dye microparticles. Therefore the core-shell dye microparticles are the only coloring agent of the ink according to the present disclosure. Even more specifically the ink does not contain any pigment.

Still more specifically the ink does not contain any other microparticles or nanoparticles or resin particles (even colorless ones) than the core-shell dye microparticles.

In an advantageous embodiment the ink according to the present disclosure is a non-photochromic ink. For the purposes of the present disclosure, the term “non-photochromic ink” is intended to mean any ink which will not be erased or will not change its color due to a change in UV light such as an increase or a decrease.

More specifically the aqueous ink composition is not an emulsion. More specifically, the composition according to the disclosure is essentially free of a solvent which is immiscible with water, in particular does not comprise an organic solvent which is immiscible with water. According to this preferred embodiment, only the core of the microparticles comprise an organic solvent immiscible with water, in particular the rest of the ink composition does not comprise a solvent which is immiscible with water.

The ink composition according to the disclosure shows good stability, in particular with regards to the dispersion of the microparticles; more specifically no sedimentation phenomenon is to be observed.

The present disclosure concerns also a writing instrument, in particular a pen such as a ball-pen, a roller pen, a felt pen, a marker, more specifically it is a ball pen, containing the erasable aqueous non-thermochromic writing ink according to the present disclosure. More specifically the writing instrument according to the present disclosure contains a rubber, in particular located on the cap or on the non-writing end of the writing instrument, more particularly the rubber being made of a blend of ethylene-propylene-diene monomer rubber and polypropylene.

Even more specifically the writing instrument according to the present disclosure comprises:
an axial barrel containing the erasable aqueous non-thermochromic writing ink according to the disclosure, and
a pen body which delivers the erasable aqueous non-thermochromic writing ink stored in the axial barrel.

The present disclosure also concerns a process of preparation of the erasable aqueous non-thermochromic writing ink according to the present disclosure, comprising the following steps:

a—preparation of the core-shell dye microparticles dispersed in water;

b—addition of the preparation obtained in step a) in an aqueous ink composition;

c—recovery of the erasable aqueous non-thermochromic writing ink obtained in step b).

Step a) of the process according to the present disclosure can be any micro-encapsulation process known conventionally in the art such as
any chemical process which rely on in situ formation of coating microcapsules such as interfacial polymerization or polycondensation, these processes being the preferred ones;
any physicochemical process, such as phase separation or coacervation, by solvent evaporation-extraction, by thermal gelation of emulsions (hot-melt) or
any mechanical process, such as spray-drying, droplets gelation or freezing, spray-coating.

More specifically the resin precursor used in step a) is soluble in water. More specifically the core-shell dye microparticles in step a) are obtained by the use of in situ polymerization, in particular from melamine resin.

At the end of step a), slurry of the microparticles dispersed in water can be obtained.

More specifically the process according to the present disclosure comprises before step b) a step a1) of preparation of an aqueous ink composition. This step a1) can be carried out by any method known by the one skilled in the art such as the mixing of the ink ingredients, in particular under agitation, even more specifically under heating, for example at 30° C.

Step b) of the process according to the present disclosure can be carried out under heating, more specifically at a temperature between 25 and 40° C., in particular at 30° C. It is more specifically carried out under agitation.

The ink obtained in step b) can be homogenized during a certain period of time, more specifically several hours, in particular at least 3 hours.

Finally the present disclosure concerns the use of core-shell dye microparticles, wherein the core of the core-shell dye microparticles comprises an organic solvent immiscible with water and at least one dye soluble in the organic solvent and the shell includes a resin component, as a coloring agent in an aqueous non-thermochromic writing ink, in particular as described above, more specifically as the only coloring agent.

In particular the core-shell dye microparticles are as described above. Even more specifically the aqueous non-thermochromic writing ink is an erasable ink, such as described above.

The present disclosure will be understood more clearly in the light of the example which follows, which is given in a non-limiting way.

### EXAMPLE

### Example 1: Preparation of an Erasable Aqueous Non-Thermochromic Writing Ink According to the Disclosure

a) preparation of the core-shell dye microparticles according to the disclosure:

10 parts of Solvent yellow 14 dye are added to 90 parts of octadecane-1-ol at 70° C. until complete dissolution.

3.6 parts of an aqueous solution of anhydride maleic/methylvinylether copolymer (33% by weight of copolymer in water) are neutralized with 4.4 parts of aqueous solution of sodium hydroxide (1M). This solution is diluted with 46.4 parts of water. This solution is homogenized with high speed homogenizer at a minimum speed of 5 m·s⁻¹. 27.8 parts of the previous mix with dye and octadecane-1-ol solution are added to the reaction mixture. This reaction mixture is emulsified at 80° C. for 30 minutes.

17.8 parts of a melamine/formaldehyde pre-polymer solution (50% weight solution of pre-polymer in water) are added dropwise to the reaction mixture. The reaction mixture is homogenized at 5 m·s⁻¹ at 90° C. for 4 hours.

A slurry (dispersion of microcapsules in water) containing approximatively 35% by weight of microcapsules, is obtained. The D50 mean in intensity particle size diameter was measured as being 5.8 μm via dynamic light scattering (Malvern Mastersizer 3000E).

b) Yellow ink preparation protocol:

10.5 parts of glycerin are heated at 30° C., 0.2 parts of benzotriazole, 0.1 parts of 1,2-benzisothiazolin-3-one aqueous solution (containing 2.5 weight % 1,2-benzisothiazolin-3-one in water), 0.1 parts of 2-methyl-4-isothiazolin-3-one aqueous solution (containing 2.5 weight % 2-methyl-4-isothiazolin-3-one in water) are added. After dissolution, 0.5 parts of xanthan gum are added. After dispersion of the xanthan gum, 28.6 parts of demineralized water is added slowly. After complete addition of the demineralized water, the previously made slurry (60 parts) is slowly added. The mixture is homogenized 3 hours at 30° C.

This ink is degassed under reduced pressure. The ink obtained is a gel ink for ball point pen.

The erasability of the yellow thus obtained is evaluated by measuring the color difference (ΔE) of the ink before and after erasing.

The color difference is measured using a spectro-colorimeter (Spectrocolorimeter Konica Minolta—Illuminated with a CIE D65 light source and measured 10° observer angle) Protocol:
1. A writing mark is realized with the ink as prepared above using a ball point pen on standard paper ISO12575.
2. The writing mark is erased with a rubber (BIC Plast-Office) a few minutes after writing.
3. The erased writing mark is measured with the Spectrocolorimeter Konica Minolta.
4. Measurement of ΔE (difference between the erased writing mark and the blank paper)

If the color difference ΔE is less than 10, then the erasability is good.

In this experimental test, ΔE=4.2

1. Erasable aqueous non-thermochromic writing ink comprising core-shell dye microparticles, wherein the core of the core-shell dye microparticles, comprises an organic solvent immiscible with water and at least one dye soluble in the organic solvent and the shell includes a resin component and wherein the core-shell dye microparticles have a mean diameter D50 measured by dynamic light scattering in the range 4-20 μm.

2. Erasable aqueous non-thermochromic writing ink according to claim 1, wherein the core-shell dye microparticles have a mean diameter in intensity D50 measured by dynamic light scattering in the range 4-15 μm.

3. Erasable aqueous non-thermochromic writing ink according to claim 1, wherein the core-shell dye microparticles are microspheres.

4. Erasable aqueous non-thermochromic writing ink according to claim 1, wherein the amount of the core-shell dye microparticles in the ink is within the range 5-40 weight %, based on the total weight of the ink.

5. Erasable aqueous non-thermochromic writing ink according to claim 1, wherein the organic solvent of the microparticle's core is immiscible with water and selected in the group consisting of petroleum solvents esters, ethers, aryl ethers and arylalkyl ethers glycol ethers, fatty alcohols, amines, terpenes, naphthenic solvents, halogenated solvents, chlorinated diphenyl, chlorinated paraffin and monochlorobenzene, ketones, cottonseed oil, groundnut oil, silicone oil, tricresyl phosphate, partially hydrogenated terphenyls, alkylated diphenyls, and any mixtures thereof.

6. Erasable aqueous non-thermochromic writing ink according to claim 1, wherein the organic solvent content of the microparticle's core is in the range 75-98 weight % based on the total weight of the microparticle's core.

7. Erasable aqueous non-thermochromic writing ink according to claim 1, wherein the dye content of the microparticle's core is in the range 2-25 weight % based on the total weight of the microparticle's core.

8. Erasable aqueous non-thermochromic writing ink according to claim 1, wherein the resin of the shell's microparticle is selected in the group consisting of polymer of urethane resin, melamine resin, urea resin, benzoguanamine resin, phenol resin, epoxy resin, and natural polymers.

9. Erasable aqueous non-thermochromic writing ink according to claim 1, wherein it comprises a rheology modifying agent.

10. Erasable aqueous non-thermochromic writing ink according to claim 1, wherein the ink contains other additives.

11. Erasable aqueous non-thermochromic writing ink according to claim 1, wherein the ink is erasable by peeling.

12. Erasable aqueous non-thermochromic writing ink according to claim 1, wherein the core-shell dye microparticles are the only coloring agent of the ink.

13. Writing instrument containing the erasable aqueous non-thermochromic writing ink according to claim 1.

14. Writing instrument according to claim 13, wherein it contains a rubber.

15. Process of preparation of the erasable aqueous non-thermochromic writing ink according to claim 1, comprising the following steps:
a—preparation of the core-shell dye microparticles dispersed in water;
b—addition of the preparation obtained in step a) in an aqueous ink composition;
c—recovery of the erasable aqueous non-thermochromic writing ink obtained in step b).

16. (canceled)

17. Erasable aqueous non-thermochromic writing ink according to claim 2, wherein the core-shell dye microparticles have a mean diameter in intensity D50 measured by dynamic light scattering in the range 4-12 μm.

18. Erasable aqueous non-thermochromic writing ink according to claim 1, wherein the ink contains at least a water miscible solvent.

19. Erasable aqueous non-thermochromic writing ink according to claim 18, wherein the water miscible solvent is present in an amount ranging from 5 to 50 weight %, relative to the total weight of the aqueous ink.

20. Erasable aqueous non-thermochromic writing ink according to claim 1, wherein the aqueous ink composition is not an emulsion.

21. Erasable aqueous non-thermochromic writing ink according to claim 1, wherein the composition is essentially free of a solvent which is immiscible with water.
